(19) United States
(12) Patent Application Publication
(10) Pub. No.: US 2007/0172542 A1
(43) Pub. Date: Jul. 26, 2007

(54) Stimulant-containing nutrition bar product and method of manufacture

(75) Inventor: David L. Krogsgaard, Oceanside, CA (US)

Correspondence Address: Shirley L. Church, Esq.;DUCKOR SPRADLING METZGER & WYNNE, A Law Corporation, San Diego, CA, 92101-7909, US

(73) Assignee: Next Proteins, Inc.

(21) Appl. No.: 11/488,536

(22) Filed: Jul. 17, 2006

Related U.S. Application Data
(60) Provisional application No. 60/700,546, filed on Jul. 18, 2005.

(51) Int. Cl. A23G 4/18; B65D 85/02

(52) U.S. Cl. 426/5; 426/72

(57) ABSTRACT

A stimulant-containing nutrition bar where the stimulant added to the bar exhibits a physical structure which is compatible with the manufacturing process used to prepare a nutrition bar. Simultaneously, the physical structure and the chemical composition of the stimulant reduces the amount of bitter taste which is experienced by a person eating the nutrition bar. Stimulants of the kind which are useful in the nutrition bar must be approved as food grade materials and are typically selected from the group consisting of caffeine, theobromine, green tea with high EGCG, taurine, ginseng, synephrine, and combinations thereof. The amount of stimulant present in the nutrition bar ranges from about 0.08% by weight to about 0.16% by weight of the nutrition bar.

### RELATED APPLICATIONS

This application is related to U.S. Provisional Application, Ser. No. 60/700,546, filed Jul. 18, 2005, which is currently pending. Priority is claimed under Provisional Application Ser. No. 60/700,546.

### BACKGROUND OF THE INVENTION

1. Field of the Invention

The invention relates generally to a stimulant-containing nutrition bar and to a method of making it. More particularly, the composition and structure of the stimulant and the overall composition of the nutrition bar into which the stimulant is incorporated is described. In addition, the method of manufacturing a nutrition bar with the stimulant incorporated is described.

2. Background Art

This section of the application describes the background of the disclosed embodiments of the present invention. There is no intention, either express or implied, that the background art discussed in this section legally constitutes prior art.

Confectionary candy products are frequently used to provide a rapid source of energy through supply of sugars which can be converted to generate energy within the body. Recently a variety of more healthy confectionary products which contain increased levels of protein, often in combination with vitamin and mineral nutrients has been offered in the form of nutrition or health food bars, for example. New food products are being designed to serve the needs of a purchaser with specific requirements.

Even chewing gum may be used to deliver specific compounds to the body on a timed release basis. ASPERGUM®, which contains aspirin for timed release has been available for over 40 years. More recently, chewing gum has been used to provide caffeine in a physically modified form which provides a timed release in the mouth.

This is described in U.S. Pat. No. 6,165,516, issued Dec. 26, 2000 to Gudas et al., and in U.S. Pat. No. 6,444,241, issued Sep. 3, 2002 to Tyrpin et al. These patents describe a method for producing a chewing gum with a controlled release of caffeine, where the caffeine is physically altered either to speed up release or to slow down release by modifying the physical structure of the caffeine. The physical structure of the caffeine may be modified by techniques including encapsulation by a coating, partial coating by agglomeration, entrapment by absorption, or a combination of these listed techniques. (Abstract) In some instances, a gum pellet is formed and a coating which contains a sugar or a polyol and caffeine or a caffeine salt compound is applied over the surface of the gum pellet (Please see the '241 patent claims). In other instances, caffeine is mixed with an encapsulating agent to form a physically-modified caffeine having an increased release rate and then a quantity of this physically-modified caffeine is added to a chewing gum formation to provide a caffeine level in the gum from about 0.2% to about 5%. (Please see the '516 patent claims).

Caffeine (C₈H₁₀N₄O₂) is the common name for trimethylxanthine. Caffeine is naturally produced by several plants, including coffee beans, guarana, yerba mate, cacao beans, and tea. In humans, caffeine is believed to block adenosine receptors in the brain and in other organs. This reduces the ability of adrenaline to bind to the receptors which typically slow down cellular activity. As a result, nerve cells which release adrenaline operate at a faster rate, leading to an increase in heart rate, blood pressure, and blood flow to muscles, all of this accompanied by an increased release of glucose by the liver. Caffeine also stimulates the body to increase levels of the neurotransmitter dopamine. This combination of effects generated by caffeine in the body provides an overall stimulation which may be used to increase the functional performance rate of the body.

While it may be desirable to make use of caffeine on a limited basis (typically about 300 milligrams per day or less in an adult), to provide stimulation while avoiding the onset of caffeine intoxication, the addition of caffeine to a food product can result in a very bitter taste. The bitterness can be masked somewhat by the addition of sweeteners and flavorings; however, to provide increased flexibility in the taste of the food product, it would be highly desirable if minimal caffeine were released in the mouth during consumption of the food product. The manner in which caffeine release may be controlled depends upon the food product itself and the method by which the food product is manufactured.

The food product developed in the present instance is a nutrition bar, and the goal was to find a technique for incorporation of a stimulant into the nutrition bar, while reducing the effect of the stimulant on the taste of the nutrition bar. In addition, the method of incorporation of the stimulant had to be compatible with available production apparatus used in the manufacture of a nutrition bar.

### BRIEF DESCRIPTION OF THE DRAWINGS

FIG. 1 shows a schematic side view of a processing apparatus which is useful in the manufacture of a nutrition bar.

FIG. 2A shows a schematic bottom view derived from a photograph of a chocolate-coated nutrition bar, where the overall structure of the bar was too soft at the time it entered the enrober for chocolate application.

FIG. 2B shows a schematic bottom view derived from a photograph of a chocolate-coated nutrition bar, where the overall structure of the bar was sufficiently rigid at the time it entered the enrober for chocolate application.

### DETAILED DESCRIPTION OF EXEMPLARY EMBODIMENTS

As a preface to the detailed description presented below, it should be noted that, as used in this specification and the appended claims, the singular forms “a”, “an”, and “the” include plural referents, unless the context clearly dictates otherwise.

When the word “about” is used herein, this indicates that the nominal value presented is accurate to within ±10%.

A stimulant-containing nutrition bar has been developed where the stimulant added to the bar exhibits a physical structure which is compatible with the manufacturing process used to prepare a nutrition bar. Simultaneously, the physical structure and the chemical composition of the stimulant reduces the amount of bitter taste which is experienced by a person eating the nutrition bar.

Stimulants of the kind which are useful in the nutrition bar must be approved as food grade materials and are typically selected from the group consisting of caffeine, theobromine, green tea with high EGCG (epigallo catechin-3-gallate), taurine, ginseng, synephrine, and combinations thereof. The amount of stimulant present in the nutrition bar ranges from about 0.08% by weight to about 0.16% by weight of the nutrition bar.

At least a portion of the surface of the stimulant is coated with a food grade material which, in combination with other ingredients present in the nutrition bar, prevents a person eating the nutrition bar from experiencing a bitter taste or gritty mouth feel. The coating material must be one which does not fracture in the blender which is used to blend the coated stimulant into at least one other material which is present in the nutrition bar. Typically, but not by way of limitation, the coated stimulant is blended into a dough which forms the main body or base of the nutrition bar. The coating material must be one which does not melt at mouth temperature and which is not water soluble. The intent is that the coating material be dissolved by stomach acids and not by saliva in the mouth. The coating material must also be able to withstand the temperatures experienced by the portion of the nutrition bar in which the coated stimulant is present without melting during the nutrition bar formation process. This formation process will be discussed subsequently herein.

The coating material is typically a fat, since food grade materials include a number and variety of fats, many of which add a pleasing flavor and creaminess to the overall composition of a nutrition bar. A fat of the kind useful as a coating material is a solid at room temperature triglyceride found in adipose animal tissue or in the seeds of plants. Fats are generally insoluble in water, but soluble in organic solvents. In the embodiments described herein stearins are used as the stimulant coating. Stearin is a white crystalline substance, glyceryl stearate. The melting temperature of the coating material used to coat the stimulant should be higher than about 80° F., and commonly ranges between about 80° F. and about 160° F. The amount of coating applied over the surface of the stimulant typically ranges from greater than 10% by weight up to about 50% by weight of the combined weight of coating and stimulant. Commonly, the amount of coating applied over the stimulant surface ranges from about 15% by weight to about 40% by weight of the combined weight of coating and stimulant. Due to the performance vs. cost of the coating material, frequently the amount of coating applied over the stimulant surface ranges from about 20% by weight to about 30% by weight, more typically from about 23% by weight to about 27% by weight.

While the coating need not cover the stimulant to the point that the stimulant is totally encapsulated, the surface coverage needs to be sufficient that the amount of caffeine available to be tasted is insufficient to create a bitter taste in the mouth during chewing and swallowing a bite of the nutrition bar.

If the amount of coating applied over the stimulant surface is excessive, the coating has a greater tendency to fracture during mixing of the coated stimulant into the dough or other constituent material of the nutrition bar. This not only causes the mixing to be inhomogeneous, but also may cause the overall texture of the nutrition bar to become grainy. One skilled in the art will be able, with minimal experimentation, to adjust the amount of coating on the surface of the stimulant, depending on the composition of the portion of the nutrition bar into which the coated stimulant is mixed. so that the mixing process is compatible and the mixed product is not grainy.

The nutrition bar overall composition must be such that the amount of chewing which is typically carried out prior to swallowing of a bite of the nutrition bar does not result in a fracture of the coating sufficient to produce a bitter taste in the mouth. This means the nutrition bar overall composition needs to be creamy rather than crunchy. Typically the overall composition of the nutrition bar is such that at least 45% by weight of the nutrition bar is creamy in texture. One skilled in the art can, with minimal taste testing determine whether a nutrition bar overall composition needs to be adjusted to be more creamy, since a taste which is sufficiently bitter to be undesirable will be experienced in instances where the overall composition is not sufficiently creamy.

It is necessary to control the temperature of the structure which is becoming the nutrition bar, as the bar is formed, so that the coating over the stimulant is not melted, exposing large surface areas of uncoated stimulant. This is discussed in detail subsequently herein. Further, it is necessary to control the temperature of the nutrition bar at the time of application of the exterior coating on the nutrition bar (a chocolate coating is common, for example). Such coatings are typically applied in an enrober, where the exterior coating is applied over the upper surface of the nutrition bar by immersion in a molten cascade of coating material, while the bottom surface of the nutrition bar structure travels on a wire mesh conveyor belt which is immersed about one quarter of an inch in the coating material. If the temperature of the nutrition bar structure is sufficiently high, the nutrition bar structure softens and begins to sag into the wire mesh conveyor belt, and may become attached to the wire mesh, making the bar difficult to remove from the conveyor. In addition, the exterior coating is generally applied in a manner such that excess coating is collected and recycled. If this coating material becomes contaminated by other components of the nutrition bar structure which fall through the conveyor belt, the product produced will not be attractive, weight control of the product is affected, and handling is difficult. In addition, the shelf life of the nutrition bar may be reduced. We have determined that when the nutrition bar is higher in sugar and of a low protein content, typically below about 20% protein by weight, the main body of the nutrition bar structure should be at a temperature ranging from about 60° F. to about 75° F. at the time the exterior coating is applied. When the nutrition bar is lower in sugar and higher in protein content, where the protein content ranges from about 25% by weight to about 40% by weight, the main body of the nutrition bar structure should be at a temperature ranging from about 80° F. to about 90° F. at the time the exterior coating is applied.

The above described features related to the invention are described in more detail subsequently herein.

### EXEMPLARY EMBODIMENTS

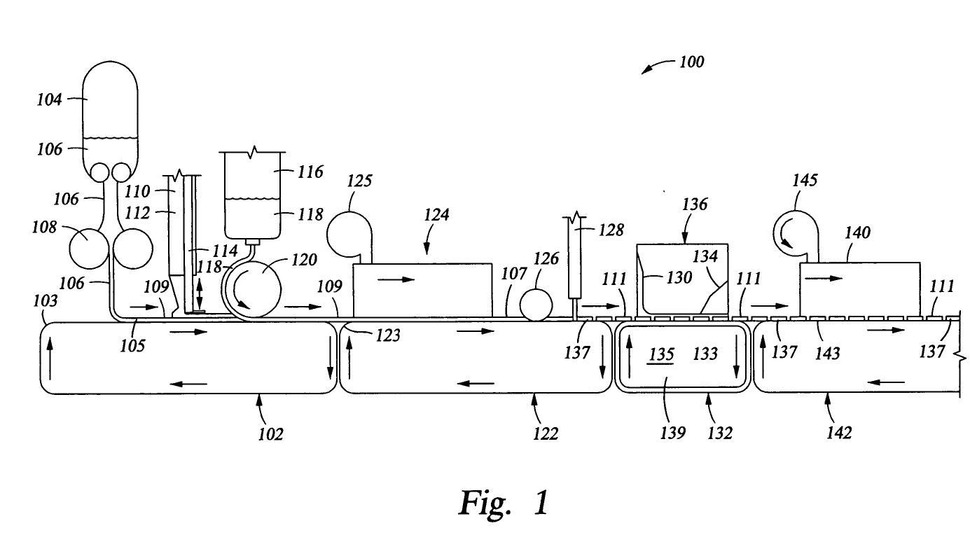

FIG. 1 shows an apparatus of the kind which can be used to manufacture a nutrition bar. The unique characteristics of each apparatus used to manufacture the nutrition bar place constraints on the composition of the nutrition bar and on the process conditions which may be used during manufacture of the nutrition bar. It is not intended that the nutrition bar composition or the method of manufacturing the nutrition bar be limited by the description of the apparatus provided in FIG. 1. The description provided below is exemplary, so that one skilled in the art can develop similar apparatus, nutrition bar compositions, and methods of manufacture with minimal experimentation.

An apparatus 100 shown in FIG. 1, which may be used in the manufacture of nutrition bars, includes a first conveyor belt 102, typically fabricated from a fluorocarbon-containing polymeric material to form a solid non-stick surface 103. A container 104 is used to supply the material which forms the main body or base layer of a nutrition bar.

The material used to form the main body is typically a dough 106. The dough typically includes various sugars, polyols, non-polyols, and artificial sweeteners of the kind known in the art; proteins; fats; flavorings; and specialized additives, such as emulsifiers, depending on the product. Examples of the kinds of natural and artificial sweeteners include powdered sugar, glycerine, sucrose, neotame, and inulin, not by way of limitation. The proteins in dough 106 may be in the form of wheat protein, soy protein, whey, whey isolates, and combinations thereof, by way of example and not by way of limitation. The dough typically contains a modified food starch which acts as a flow and mixing aid. In one of the more commonly used embodiments of a caffeine-containing nutrition bar, the coated stimulant is mixed into the dough 106.

In a low protein embodiment of the dough, where the protein content in the dough ranges from about 13% by weight of the dough to about 22% by weight of the dough, a nutrition bar of the kind described herein may employ a sufficient quantity of sugar to help serve as a filler, which provides not only a source of immediate energy, but also a bulkier size for the resulting bar. The sugar is relatively inexpensive, as compared to other fillers such as protein. However, as the sugar content of the nutrient bar is increased, even though the sugar has been converted from an initial crystalline form of raw material into a noncrystalline form within the dough, it may, under certain circumstances, recrystallize within the nutrition bar during manufacture of the bar. Recrystallization adversely affects consistency of the nutrition bar in general, causing a grainy texture. The recrystallization of the sugar may be reversed by taking the nutrition bar temperature above about 150° F. However, at such high temperature, the coating on the stimulant incorporated into the dough would melt and the effectiveness of the coating would be reduced, possibly to the point the coating does not prevent a bitter taste in the nutrition bar. Thus, it is important that when the coated stimulant is incorporated into the dough, the temperature of at least the dough portion of the nutrition bar not rise above the temperature at which the coating material melts.

In addition, in a low protein embodiment of the dough, the liquid content of the dough is particularly important, to maintain structural stability of the dough. The liquid content of the dough typically ranges from about 15% by weight to about 22% by weight. The water content of the liquid is carefully controlled, due to the high sugar concentration, so that the water portion of the liquid makes up from about 1.0% by weight to about 4.50% by weight, typically about 3.5% by weight to about 4.0% by weight of the dough.

In the low protein embodiment of the nutrition bar, to ensure that the temperature of the core layer 107 (which is formed from the dough 106) is adequate to maintain the protective surface of the coating over the stimulant and to maintain adequate structural rigidity during processing of the nutrition bar to finished product, the liquids added to the dough may be cooled to a temperature ranging from about 50° F. to about 55° F. prior to mixing, and the mixed dough may be refrigerated to a temperature ranging from about 50° F. to about 55° F. prior to being deposited as the sheet of core 107 material on conveyor belt 102.

In a high protein embodiment of the dough, where the protein content in the dough ranges from about 38% by weight of the dough to about 62% by weight of the dough, the liquid content of the dough does not need to be as carefully controlled. The liquid content may range from about 30% by weight to about 40% by weight of the dough. The water content of the liquid is controlled to make up from about 7.0% by weight to about 15% by weight of the dough.

In the high protein embodiment of the nutrition bar, the temperature of the core layer 107 can be considerably higher. It is not necessary to cool the liquids added to the dough 106, and it is not necessary to refrigerate the dough after mixing; so, the dough, which is typically at a temperature of about 80° F. to about 100° F. after mixing, can be sent directly to the extruding rollers 108 after mixing.

The dough 106 is fed through rollers 108 (or another depositing apparatus), to provide a sheet or layer of “core” material 107 which travels on the upper surface of conveyor belt 102. Other components of a nutrition bar may be deposited over the core layer 107. For example, in the manufacture of a nutrition bar of the kind illustrated in FIG. 1, peanuts 112 are fed from a peanut container 110 onto the upper surface 105 of core layer 107, where the peanuts 112 are depressed into the surface 105 of core layer 107 by the action of a pressing device 114. Subsequently caramel 118 is applied from a caramel container 116 onto the surface of a caramel wheel 120, which is used to apply the caramel over the upper surface 105 of the core layer 107 and the peanuts 112 which have been pressed into the upper surface 105 of core layer 107.

Once the layers of the nutrition bar have been deposited, the nutrition bar is transferred onto another conveyor belt 122 which also typically comprises a solid surface 123 which is a non-stick surface such as a polymerized fluorocarbon surface. The core layer 107 with overlying layer of caramel and peanuts 109 is then processed through a first cooling tunnel 124 which makes use of cold air convection cooling unit 125 to provide cooling to this layer and the underlying core layer 107. The overall temperature of a low protein nutrition bar is typically in the range of about 60° F. to about 75° F. after exiting the cooling tunnel 124. The overall temperature of a high protein nutrition bar is typically in the range of about 80° F. to about 90° F. after exiting cooling tunnel 124. This temperature is dictated by the processing steps which follow. For example, a slitter 126 with multiple slitting blades (not shown) is used to slit the core layer 107 and overlying layer 109 into strips, followed by a guillotine 128, which is used to cut the slit layers into bars 111. If the bar temperature is too high, causing the core layer 107 to be too soft, the caramel layer, peanuts included, illustrated as layer 109 in FIG. 1, peels up at the slitter, leaves the surface 105 of core layer 107 and wraps around the slitter 126. To avoid this, the overall average temperature of the core layer 107 and overlying layer 109 should be below about 70° F., and typically ranges from about 60° F. to about 70° F.

If the overall temperature of the nutrition bar 111 is too low, it may not be possible to slice the caramel, and the ends of the nutrition bar 111 may tend to crush and spread when they are guillotined, providing a poor appearance and making packaging difficult. Considering this, the overall temperature of the multiple layers 107 and 109 should not be below about 60° F.

Once the multiple layered nutrition bar layer has been sliced and cut into individual bars 111, these bars are frequently coated with an exterior coating which provides a desired flavor and texture and assists in improving the shelf life of the nutrition bar. A common, popular coating is chocolate. Chocolate coatings are applied to encapsulate the interior of the nutrition bar as nearly as possible. Typically the nutrition bar is not completely encapsulated, as there are a few minor breaches in the coating on the bottom of the nutrition bar which is in contact with the conveyor belt which is present while the chocolate coating is applied. Commonly in the industry, an enrober 136 is used to apply a chocolate material 135 onto the surface of the nutrition bars 111, as illustrated in FIG. 1. The chocolate is applied from an enclosure 138 above the conveyor belt 132 and from an enclosure 139 below the conveyor belt 132.

The chocolate applied to the upper surface of nutrition bars 111 from enclosure 138 is applied using a “waterfall” 130 of chocolate which falls over the upper surface of nutrition bars 111 as they pass under the waterfall. Excess chocolate coating may be blown off the surface and into underlying enclosure 139 by an air knife 134, as illustrated in FIG. 1. The conveyor belt 132 is a wire mesh structure 133, and the chocolate coating material 135 applied to the bottom of nutrition bars from enclosure 139 is applied through the wire mesh structure 133, which is submersed about one quarter inch into the level of the chocolate material 135 contained in enclosure 139. Toward the end of conveyor belt 132, the wire mesh structure 133, supported by a roller (not shown) rises above the surface level of chocolate material 135, where a lick roller (not shown) removes excess chocolate from the bottom of the nutrition bar 111.

If the overall temperature of the nutrition bar 111 is too high at the time it is transferred to the surface of conveyor belt wire mesh structure 133, the bar will sink into the wire mesh structure 133, become entangled there and cause problems. The bar is difficult to remove from the conveyor belt 132 and materials from the main body of the nutrition bar 111 will pass through the wire mesh structure 133 and contaminate the chocolate material 135 in enclosure 139. Not only does this interfere with the application of chocolate material 135, but the nutrition bar 111 is not attractive after the chocolate coating and adheres to the conveyor belt 142 which is used to move the chocolate-coated nutrition bars to a second cooling tunnel 140 which is used to set the chocolate on the nutrition bar 111.

Since the temperature of the liquid chocolate which is applied over the surface of the nutrient bar 111 is typically in the range of about 105° F. and about 115° F., and since heat will be transferred from this coating material to the nutrient bar 111, some cooling of the nutrient bar 111 is required to compensate for this heat transfer.

Considering all of the factors involved, the overall temperature of the core layer 107 of a low protein bar entering the enrober should range between about 60° F. and about 75° F., and the temperature of the core layer 107 of a high protein bar entering the enrober should range between about 60° F. and about 90° F. Subsequent to leaving the enrober 136, the nutrition bars 111 are passed through a second cooling chamber 140 which sets the chocolate exterior coating 137 using cooling from cold air convection cooling unit 145. The conveyor belt 142 used to transport the nutrition bars 111 with exterior coating 137 typically presents a solid, non-stick surface of the kind previously described. The cooled, coated nutrition bars 111 are then unloaded from conveyor belt 142 and packaged for sale (not shown).

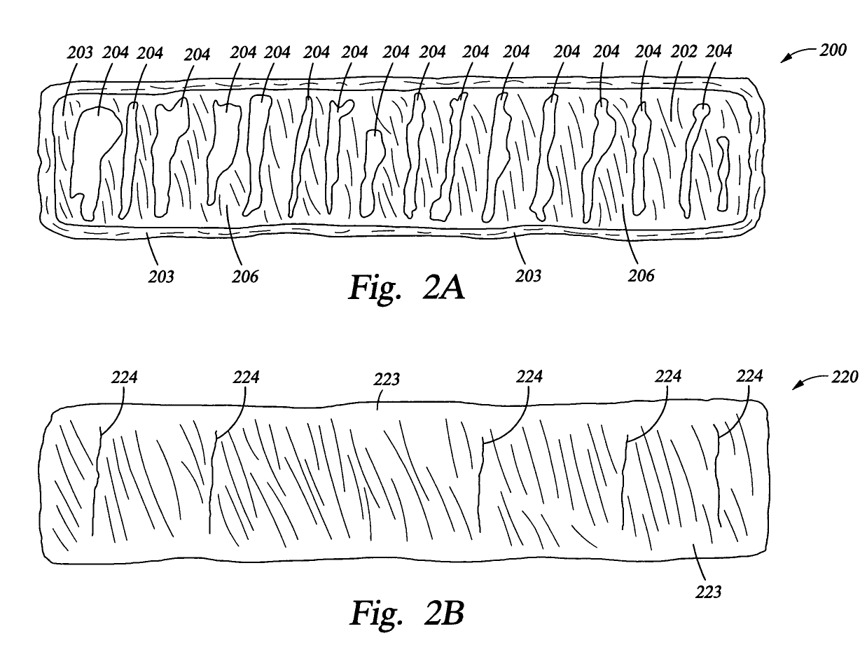

FIGS. 2A and 2B illustrate the difference between a low protein nutrition bar which was too soft at the time it entered the enrober 136, and one which was at the proper temperature. FIGS. 2A and 2B are schematics illustrating the bottom surface of the nutrition bar 111 which was in contact with the surface of the wire mesh structure 133. In FIG. 2A, a chocolate-coated nutrition bar 200 bottom surface 203 shows a number of irregularities, where the bottom surface 204 of the core layer 107 protrudes through the chocolate 202. This effect was caused by the nutrition bar 111 overall temperature being too high (at about 80° F.) at the time the bar entered the enrober 136. In FIG. 2B, a chocolate-coated nutrition bar 220 bottom surface 223 shows a good finish, where there is no protrusion of the core layer 107, and the only evidence of contact with the wire mesh structure 133 of enrober 136 are a few minor lines or cracks in the chocolate layer surface 223. This good result was achieved when the same nutrition bar 111 composition as that illustrated with respect to FIG. 2A was applied at a core layer 107 temperature of about 70° F.

While the invention has been described in detail above with reference to particular exemplary embodiments, various modifications within the scope and spirit of the invention will be apparent to those of working skill in this technological field. One skilled in the art, upon reading applicants'disclosure, purchase processing apparatus and adjust process variables, to achieve the effects which are required by the concept and practical aspects of the invention.

The claims which are appended are representative of the subject matter which is described herein. These claims, while limiting the subject matter which the inventors would be able to protect by a patent issued with these claims, are not intended to be limiting with respect to subject matter which may later be claimed in view of the disclosure herein.

We claim:

1. A stimulant-containing nutrition bar, where the amount of stimulant present in the nutrition bar ranges from about 0.08% by weight to about 0.16% by weight of the nutrition bar, wherein the stimulant added to the nutrition bar is at least partially coated with a food grade organic polymer which melts at a temperature in excess of about 80° F., and wherein an amount of food grade organic polymer coating present is greater than 10% by weight of the combined weight of coating and stimulant, whereby the taste of the nutrition bar is not bitter.

2. A stimulant-containing nutrition bar in accordance with claim 1, wherein the composition of at least 45% by weight of the nutrition bar is creamy in texture.

3. A stimulant-containing nutrition bar in accordance with claim 2, wherein said food grade organic polymer is a fat.

4. A stimulant-containing nutrition bar in accordance with claim 3, wherein the fat is a triglyceride.

5. A stimulant-containing nutrition bar in accordance with claim 4, wherein the triglyceride is stearin.

6. A stimulant-containing nutrition bar in accordance with claim 1 or claim 2, or claim 3, or claim 4, or claim 5, wherein the stimulant is selected from the group consisting of caffeine, theobromine, green tea with high EGCG, taurine, ginseng, synephrine, and combinations thereof.

7. A stimulant-containing nutrition bar in accordance with claim 6, where the amount of the food grade organic polymer coating applied over a surface of the stimulant rages between about 10% by weight and about 50% by weight of the combined weight of coating and stimulant.

8. A stimulant-containing nutrition bar in accordance with claim 7, where the amount of food grade organic polymer coating ranges from about 15% by weight to about 40% by weight of the combined weight of coating and stimulant.

9. A stimulant-containing nutrition bar in accordance with claim 8, where the amount of food grade organic polymer coating ranges from about 20% by weight to about 30% by weight of the combined weight of coating and stimulant.

10. A method of manufacturing the stimulant-containing nutrition bar of claim 1, wherein the amount of coating material applied to a surface of the stimulant ranges between about 10% by weight and about 50% by weight of the combined weight of coating and stimulant, whereby the coating material does not fracture in the blender which is used to blend the coated stimulant into at least one other material which is present in the nutrition bar.

11. A method of manufacturing the stimulant-containing nutrition bar of claim 10, wherein the amount of coating material applied to a surface of the stimulant ranges from about 15% by weight to about 40% by weight of the combined weight of coating and stimulant.

12. A method of manufacturing the stimulant-containing nutrition bar of claim 11, wherein the amount of food grade organic polymer coating ranges from about 20% by weight to about 30% by weight of the combined weight of coating and stimulant.

13. A method of manufacturing the stimulant-containing nutrition bar of claim 10, or claim 11, or claim 12, wherein the coated stimulant is blended into a dough which forms the main body or base of the nutrition bar.

14. A method in accordance with claim 10 or claim 11, or claim 12, wherein the melting temperature of the coating material used to coat the stimulant is sufficiently high that the coating material does not melt during fabrication of the nutrition bar.

15. A method in accordance with claim 14, wherein the melting temperature of the coating material ranges between about 80° F. and about 120° F.

16. A method in accordance with claim 13, wherein the temperature of the dough portion of the nutrition bar at the time an exterior coating is applied to the surface of the nutrition bar is sufficiently low that the nutrition bar does not sag into a wire mesh conveyor belt used to transport the nutrition bar through an apparatus which applies the exterior coating.

17. A method in accordance with claim 16, wherein the exterior coating which is applied is a chocolate coating, and wherein the temperature of the dough ranges between about 70° F. and about 90° F.

18. A method in accordance with claim 17, wherein a protein content present in the nutrition bar ranges from about 6% by weight to about 10% by weight, and wherein the dough temperature at the time the exterior coating is applied ranges between about 60° F. and about 75° F., whereby the nutrition bar does not sag into a wire mesh conveyor belt during application of said exterior coating.

19. A method in accordance with claim 17, wherein a protein content present in the nutrition bar ranges from about 25% to about 35%, and wherein the dough temperature at the time the exterior coating is applied ranges between about 70° F. and about 90° F., whereby the nutrition bar does not sag into a wire mesh conveyor belt during application of said exterior coating.

20. A stimulant-containing low protein nutrition bar, where the amount of stimulant present in the nutrition bar ranges from about 0.17% by weight to about 0.36% by weight of the core layer of the nutrition bar, wherein the stimulant added to the nutrition bar is at least partially coated with a food grade organic polymer which melts at a temperature in excess of about 80° F., and wherein an amount of food grade organic polymer coating present is greater than 10% by weight of the combined weight of coating and stimulant, whereby the taste of the nutrition bar is not bitter.

21. A stimulant-containing low protein nutrition bar in accordance with claim 20, wherein said food grade organic polymer is a fat.

22. A stimulant-containing low protein nutrition bar in accordance with claim 21, wherein the fat is a triglyceride.

23. A stimulant-containing low protein nutrition bar in accordance with claim 22, wherein the triglyceride is stearin.

24. A stimulant-containing low protein nutrition bar in accordance with claim 20 or claim 21 or claim 22, or claim 23, wherein the stimulant is selected from the group consisting of caffeine, theobromine, green tea with high EGCG, taurine, ginseng, synephrine, and combinations thereof.

25. A stimulant-containing low protein nutrition bar in accordance with claim 24, where the amount of the food grade organic polymer coating applied over a surface of the stimulant rages between about 10% by weight and about 50% by weight of the combined weight of coating and stimulant.

26. A stimulant-containing low protein nutrition bar in accordance with claim 25, where the amount of food grade organic polymer coating ranges from about 15% by weight to about 40% by weight of the combined weight of coating and stimulant.

27. A stimulant-containing low protein nutrition bar in accordance with claim 26, where the amount of food grade organic polymer coating ranges from about 20% by weight to about 30% by weight of the combined weight of coating and stimulant.

28. A stimulant-containing high protein nutrition bar, where the amount of stimulant present in the nutrition bar ranges from about 0.12% by weight to about 0.25% by weight of the core layer of the nutrition bar, wherein the stimulant added to the nutrition bar is at least partially coated with a food grade organic polymer which melts at a temperature in excess of about 80° F., and wherein an amount of food grade organic polymer coating present is greater than 10% by weight of the combined weight of coating and stimulant, whereby the taste of the nutrition bar is not bitter.

29. A stimulant-containing high protein nutrition bar in accordance with claim 28, wherein said food grade organic polymer is a fat.

30. A stimulant-containing high protein nutrition bar in accordance with claim 29, wherein the fat is a triglyceride.

31. A stimulant-containing high protein nutrition bar in accordance with claim 30, wherein the triglyceride is stearin.

32. A stimulant-containing high protein nutrition bar in accordance with claim 28 or claim 29 or claim 30, or claim 31, wherein the stimulant is selected from the group consisting of caffeine, theobromine, green tea with high EGCG, taurine, ginseng, synephrine, and combinations thereof.

33. A stimulant-containing high protein nutrition bar in accordance with claim 32, where the amount of the food grade organic polymer coating applied over a surface of the stimulant rages between about 10% by weight and about 50% by weight of the combined weight of coating and stimulant.

34. A stimulant-containing high protein nutrition bar in accordance with claim 33, where the amount of food grade organic polymer coating ranges from about 15% by weight to about 40% by weight of the combined weight of coating and stimulant.

35. A stimulant-containing high protein nutrition bar in accordance with claim 34, where the amount of food grade organic polymer coating ranges from about 20% by weight to about 30% by weight of the combined weight of coating and stimulant.
